(19) United States
(12) Patent Application Publication
(10) Pub. No.: US 2010/0017120 A1
(43) Pub. Date: Jan. 21, 2010

(54) METHOD FOR CODING TRAFFIC MESSAGES ON THE BASIS OF TRAVEL DIRECTION AND FOR TAKING THEM INTO ACCOUNT IN THE ROUTE CALCULATION

(76) Inventors: Matthias Hessling, Hidesheim (DE); Thomas Schoeberl, Hildesheim (DE); Ernst-Peter Neukirchner, Hildesheim (DE)

Correspondence Address: KENYON & KENYON LLP, ONE BROADWAY, NEW YORK, NY, 10004, US

(21) Appl. No.: 12/308,183

(22) PCT Filed: Jul. 5, 2007
(86) PCT No.: PCT/EP2007/056825

§ 371 Date: May 15, 2009

(30) Foreign Application Priority Data
Aug. 18, 2006 (DE) 10 2006 038 845.3

(51) Int. Cl. G01C 21/36

(52) U.S. Cl. 701/209; 701/207

(57) ABSTRACT

In a method for coding traffic messages on the basis of travel direction and for taking them into account in the route calculation using a navigation system, to further provide detection of the location of traffic disruptions while taking into account the direction of travel, a stretch of road made up of segments is coded, and an item of digital information is added to the coded stretch of road, which indicates that the traffic message is to be used only if all segments of the coded stretch of road are part of a travel route. In the process, the coded stretch of road is decoded and the digital information is evaluated in a navigation device.

### BACKGROUND OF THE INVENTION

1. Field of the Invention

The present invention relates to a method for coding traffic messages on the basis of travel direction and for taking them into account in the route calculation.

2. Description of Related Art

Today's navigation systems for motor vehicles base the route calculation and the route guidance on a database, the so-called digital map. The digital map contains static information for all roads, their travel direction, costs of driving through the road, the road class, and the connection and turn information between the roads. In this context, costs are understood as the required travel time for a route section, or its length, or an expenditure that may be calculated according to other criteria, or a combination of the aforementioned expenditures. Additional items of information, such as the geometric curve shape, points of interest, information regarding the graphic representation, or the like, may also be contained in the digital map.

When a route is calculated, the static costs of the roads, the travel direction, and the turn relationships are taken into account in a cost function. Depending on the option selected (for example, “shortest” or “quickest” route), an optimum route is calculated, minimizing the total cost of all roads from the start to the destination. The driver is then directed to the destination by the navigation device in accordance with the calculated route.

Since the travel time and also the optimum route to the destination depend on the current traffic condition, information regarding traffic disruptions is also taken into account in devices having a “dynamic” navigation. To this end, broadcasting companies broadcast so-called TMC messages (“traffic message channel”). These essentially contain information regarding the traffic situation on disrupted roads. To this end, a TMC location of the road is broadcast. The road may be identified in the digital map through the comparison with a reference table. Furthermore, TMC messages contain the type of disruption. TMC event codes are provided for this purpose that describe the type of disruption, for example, free-flowing traffic, slow-moving traffic, traffic jam, or disruption.

The coded roads in the traffic message are imaged onto the roads of the digital map, and the static costs of the road are modified according to the type of disruption using the reported dynamic values. The dynamic navigation calculates in turn the optimum route to the destination by minimizing the total costs. In this way, the driver obtains an optimum route that takes into account the transmitted TMC traffic messages (e.g., see published European patent document EP 0 584 310 and published German patent document DE 195 16 476).

In traffic messages, the disrupted roads are coded using the TMC location table, AGORA location referencing method, TPEG-Loc or other methods, for example. In this instance, the disruption extends to each individual segment of a connected stretch of road (see published German patent document DE 35 36 820).

In addition, there are also disruptions at intersections and turn-offs that only affect vehicles having a specific travel direction. For example, vehicles traveling in the “straight-ahead” direction are not affected by a traffic disruption on an intersection, whereas vehicles traveling in the “turning right” direction on the same road segment may definitely be affected by the disruption.

It is not possible to code this type of location of the disruption, which is also described as a traffic event in a terminology used here, using traffic messages and referencing methods known from the related art, and thus it is not possible to consider it when calculating routes in navigation systems.

### BRIEF SUMMARY OF THE INVENTION

It is an objective of the present invention to provide a method for route calculation and route guidance which detects the location of traffic disruptions only for specific directions of travel.

The basic idea of the present invention is to separate traffic flows according to their travel routes as part of a coding of a stretch of road. To this end, in the event of a disruption, first the stretch of road associated with the disruption is coded using a location referencing method, for example. The stretch of road is made up of all segments that are required to describe the location of the disruption and the corresponding direction of travel. For example, the stretch of road may run across an intersection. Then, in the most obvious case, the stretch of road is made up of the road that leads into the intersection and the road that leads away from the intersection when the travel direction is considered. If a separate roadway for turning traffic or other roadways exist within the intersection, then these may also be part of the stretch of road. Then, an additional item of information is added that indicates that a traffic message is to be used only if all referenced segments of the coded stretch of road are also part of the route in the sequence specified in the message.

For the calculation of routes, the navigation systems may then accordingly consider the stretch of road coded in the traffic message together with the associated disruption. In the process, the coded stretch of road and the bit are evaluated in a navigation system.

The advantage of the present invention is thus that an additional item of information allows for the travel route to be considered in the coding of the location of traffic events, such as traffic disruptions on intersections, in traffic messages together with a corresponding consideration in the navigation system when calculating the route and in the graphic display. In this context, the traffic event relates only to the driving maneuver (e.g., right, left, straight-ahead) on the intersection specified in the traffic message, whereas other routes across the same intersection are not affected by the traffic event.

In the traffic messages known from the related art, the route cannot be used to distinguish whether a disruption on a road segment is relevant as part of a connected stretch of road, for example.

In traffic messages in which disruptions are to be coded selectively for particular sections of roads across intersections, these sections are preferably specified in the sequence in which they are traveled and advantageously labeled by one bit as a maneuver.

An advantageous refinement of the present invention provides that the stretch of road is linked with an item of traffic information.

A variant of the present invention provides that the informing is carried out via a visual and/or acoustic output. In a visual representation, the information may be output in a digital map by inserting country-specific traffic signs. For example, the sign from Germany “Straight-ahead driving and right turns allowed” or the sign from Switzerland “No left turn” could possibly be used. Analogous signs may also be used. When output as text, the disruption may be expressed by the formulation “Access to y Road from x Road is disrupted/blocked (due to construction).”

Preferably, the information is illustrated by a display system through turn information, or by disruption messages based on travel direction according to method step 1b), the information being taken into account when the route is calculated.

It is also conceivable for the coding to be done using a TMC location table or using the AGORA location referencing method.

Finally, the present invention provides a navigation device having a digital map, the digital map being set up such that the route calculation and route guidance takes place according the method according to the present invention.

### BRIEF DESCRIPTION OF THE SEVERAL VIEWS OF THE DRAWING

FIG. 1 is a flow chart of the method according to the present invention.

FIG. 2 shows a route guidance in the event of a traffic disruption as part of the method according to the present invention.

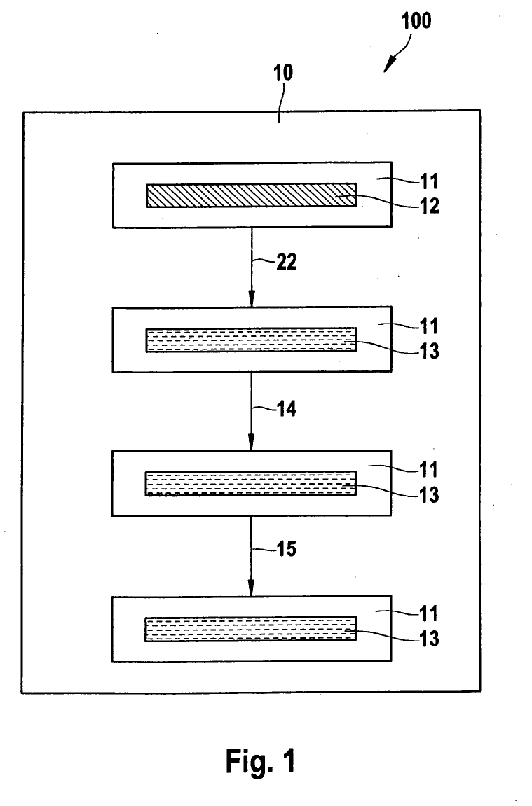

Method 100, which is illustrated schematically in FIG. 1, is used in route guidance in which the location of traffic disruptions is detected only for specific directions of travel. In this context, method 100 allows for a coding of the location of a stretch of road that is part of a digital map 11, and a separation of the traffic flows according to their travel routes.

Method 100 begins with coding 22, using a location referencing method known from the related art, of a connected stretch of road 12 that is associated with the disruption and that crosses an intersection, for example. For this purpose, stretch of road 12 is made up of all segments that are required to describe the location of the disruption and the corresponding direction of travel. One conceivable case is that the stretch of road is made up of one road that leads into the intersection and one road that leads away from the intersection when the travel direction is considered. If a separate roadway for turning traffic exists, it may also be part of stretch of road 12. Afterwards, an additional item of digital information that indicates that this traffic message is to be used only if all referenced segments of coded stretch of road 13 are part of the route in the correct sequence is added as an addition 14. One bit suffices for coding this item of information. Then, in a further method step, the coded stretch of road is communicated 15 via a traffic message. For the calculation of routes, a navigation system 10 for vehicles may then accordingly consider stretch of road 13 coded in the traffic message together with the associated disruption. In display systems, the information may be illustrated by corresponding turn information or disruption messages based on travel direction. In the process, the decoding of the coded stretch of road and the evaluation of the digital information takes place in a navigation device.

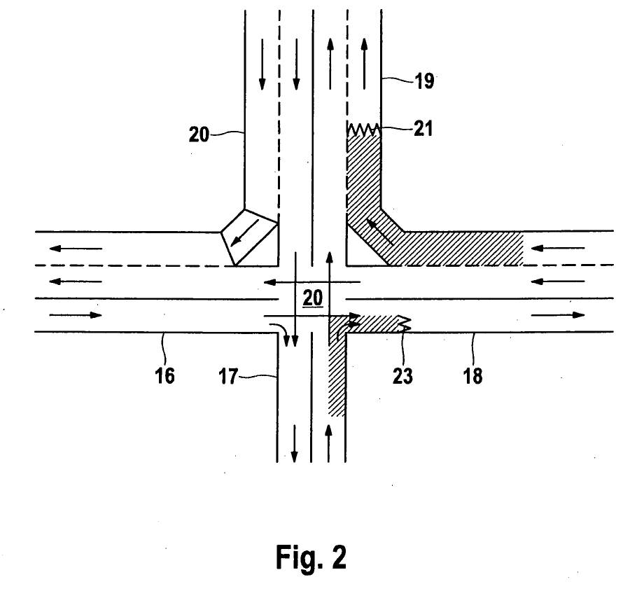

FIG. 2 shows a general intersection 20. The crossings of the intersection from road 16 to 18 and from road 17 to 19 and in the opposite direction are not disrupted. The turning maneuver (shaded region) from road 17 to 18 and from road 18 to 19 is disrupted due to construction sites 21 and 23, for example. When the location of the disruption is transmitted in a traffic message, the section for the turning maneuver must be coded. The coding methods (e.g., TMC location, table, AGORA location referencing, TPEG-Loc) allow for disrupted stretches of road made up of connected road segments to be coded. In this context, no distinction is made between possible travel routes on identical road segments.

It is not possible to code the traffic disruption, which relates only to the turning maneuver from road 17 to 18, using existing methods since it is not possible to specify for the coding a separate turning lane or roadway for turning traffic, and thus the location referencing methods are not able to distinguish whether the disruption relates only to vehicles turning right or also to vehicles traveling straight-ahead.

It would be possible to partially code the turning maneuver from road 18 to 19 using the AGORA location referencing method since a separate roadway exists for vehicles turning right on the intersection. However, the representation of the disruption depends on the digital map, whether this roadway also exists on the map as a separate roadway. This cannot be assumed. Furthermore, it is not possible to distinguish the right-hand turn-off lane and the acceleration lane from the straight-ahead lane in all location referencing methods, which means that it is likewise not possible to code the right-hand turn-off lane and the acceleration lane separately as locations of disruption.

According to the existing location referencing methods, the disrupted section (shaded region) is coded in such a way that the stretch of road in the direction of travel is coded as made up of the connected segments of road 18 and road 19, and then an additional item of information (one bit) is inserted, whereby the following is to be taken into consideration:

If the bit is not set: The location of the disruption is considered like it was previously.
Parts of road 18 are disrupted independently of the travel route. (That is, for the traffic from road 18 to 16, from road 18 to 17, and from road 18 to 19.)
Parts of road 19 are disrupted independently of the route. (That is, for traffic from 16 to 19, 17 to 19, and 18 to 19.)
The separate roadway for turning traffic between road 18 and 19 is disrupted (in the event that this information regarding the separate roadway for turning traffic between road 18 and 19 exists in the digital map and thus is able to be evaluated).

If the bit is set: The disruption is considered only as one connected maneuver.
The disruption affects only road users who drive the entire stretch of road as specified in the message. That is, drive from road 18 (via the separate roadway for turning traffic) into road 19. All other road users are not affected by the disruption. In particular, the crossing traffic from 17 to 19 and from 18 to 16 remains undisrupted.

The information about the travel route of the disruption across the intersection may be accordingly taken into account when the route is calculated in navigation devices.

Visual and textual outputs are suitable for informing the driver about this traffic message. In the visual representation, the information may be output into the maps by inserting country-specific traffic signs. By way of example, the sign from Germany “Straight-ahead driving and right turns allowed” and the sign from Switzerland “No left turn” could be used. Analogous signs could also be used. For detailed information, direction arrows having information regarding the reason for obstruction may be inserted in the map in the form of traffic signs. For example, a combination of signs could also exist that specifies “No entry when turning right,” “Hazardous area straight ahead,” “A construction site is encountered when turning left.” If more specific information regarding the disruption is to be omitted in the representation, then insertions such as “disruption,” “caution” in text form, or “hazardous area” as a sign at the intersection, suffice.

In the textual or voice output, the disruption may be described, for example, by: “Access to y Road from x Road is disrupted/blocked (due to construction).” If both road names are identical, the disruption could be described by “The passage of r Road across the intersection (with the adjoining Road/via the m Square) is disrupted/blocked.” To name the direction of the disruption in the intersection, additions may be made: “in the direction of o Road,” or “in the direction of a town,” or “in nesw direction,” nesw specifying a cardinal direction.

1-10. (canceled)

11. A method for coding road information on the basis of a travel direction and calculating a travel route at least partially based on the coded traffic information using a navigation system of a vehicle, comprising:
a) coding information regarding a stretch of road having a plurality of segments and corresponding to a driving maneuver;
b) additionally coding an item of digital information indicating that the information coded in step a) is to be used only if all segments of the stretch of road coded are actually part of a travel route;
c) communicating the coded information regarding the stretch of road via a traffic message;
d) decoding the coded information regarding the stretch of road; and
e) evaluating the decoded information in a navigation device to calculate the travel route.

12. The method as recited in claim 11, wherein the item of digital information is coded in the form of a bit.

13. The method as recited in claim 11, wherein the coding in step a) is performed using a location referencing method.

14. The method as recited in claim 11, wherein the information regarding the stretch of road is linked to an item of information regarding the traffic situation.

15. The method as recited in claim 14, further comprising:
outputting at least part of the decoded information to a driver of the vehicle by at least one of a visual output and an acoustic output.

16. The method as recited in claim 15, wherein the at least part of the decoded information is illustrated by a display system as at least one of turning information and disruption indication based on the travel direction.

17. The method as recited in claim 11, wherein the coding in step a) is carried out using a TMC location table.

18. The method as recited in claim 11, wherein the coding in step a) is carried out using AGORA-location-referencing method.

19. A vehicle navigation system, comprising:
a digital map; and
a control unit configured to perform, in conjunction with the digital map, a method for coding road information on the basis of a travel direction and calculating a travel route at least partially based on the coded traffic information, the method including:
a) coding information regarding a stretch of road having a plurality of segments and corresponding to a driving maneuver;
b) additionally coding an item of digital information indicating that the information coded in step a) is to be used only if all segments of the stretch of road coded are actually part of a travel route;
c) communicating the coded information regarding the stretch of road via a traffic message;
d) decoding the coded information regarding the stretch of road; and
e) evaluating the decoded information in a navigation device to calculate the travel route.
